(19) United States
(12) Patent Application Publication
(10) Pub. No.: US 2026/0055592 A1
(43) Pub. Date: Feb. 26, 2026

(54) DRAIN SYSTEMS

(71) Applicant: Jeffrey Glen Benson, Sweetwater, TN (US)

(72) Inventor: Jeffrey Glen Benson, Sweetwater, TN (US)

(21) Appl. No.: 18/814,555

(22) Filed: Aug. 25, 2024

(51) Int. Cl. E03F 1/00; B60R 15/00

(52) U.S. Cl. CPC E03F 1/008; B60R 15/00

(57) ABSTRACT

A drain pipe system having a drain pipe assembly including a connector bushing, a first straight coupler, a reducing coupler, a second straight coupler, and a 90 degree elbow; wherein the connector bushing, the first straight coupler, the reducing coupler, the second straight coupler, and the 90 degree elbow are coupled in respective series as the drain pipe assembly configured for connection between a recreational vehicle and a wastewater collection system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71 (d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pipes and more specifically relates to piping connectors.

### 2. Description of the Related Art

Many people enjoy using recreational vehicles (rvs) for entertainment purposes. Many modern rvs have indoor plumbing that is for use and gets connected to a water source for potable water and to an external sewage dump for removing the temporarily stored sewage from the rv. It is desirable that efficient piping be used for such purposes and that the piping can be retrofitted to meet the application and be easy to assemble and disassemble.

Various attempts have been made to solve the above-mentioned problems such as those found in U.S. Pat. No. 4,223,702 to James Cook. This art is representative of pipe connectors. None of the above inventions and patents, taken either singly or in combination, is seen to describe the invention as claimed.

Ideally, a drain pipe system should provide ease of use for connecting and disconnecting and, yet would operate reliably and be manufactured at a modest expense. Thus, a need exists for a reliable drain pipe system to avoid the above-mentioned problems.

### BRIEF SUMMARY OF THE INVENTION

In view of the foregoing disadvantages inherent in the known pipe connectors art, the present invention provides a novel drain pipe system. The general purpose of the present invention, which will be described subsequently in greater detail is to provide a reliable and efficient means for creating connections between pipes.

A drain pipe system is disclosed herein, in a preferred embodiment, comprising: a drain pipe assembly including a connector bushing, a first straight coupler, a reducing coupler, a second straight coupler, and a 90 degree elbow; wherein the connector bushing, the first straight coupler, the reducing coupler, the second straight coupler, and the 90 degree elbow are coupled in respective series as the drain pipe assembly, configured for connection between a recreational vehicle and a wastewater collection system.

In this embodiment the connector bushing, the first straight coupler, the reducing coupler, the second straight coupler, the 90 degree elbow, each comprises pvc, the drain pipe assembly comprises pvc, and the drain pipe assembly does not comprise threads. The drain pipe assembly can be friction fit and alternately adhesively assembled. The connector bushing comprises a through hole and a plurality of lugs. The connector bushing is located on a proximal end, and the 90 degree elbow is located on a distal end; the connector bushing on the proximal end (opposing end), adjacent to the first straight coupler, adjacent to the reducing coupler, adjacent to the second straight coupler, and adjacent to the 90 degree elbow, coupled in respective series when assembled. Wastewater is able to freely travel through the drain pipe assembly.

A kit is also disclosed herein including: the connector bushing, the first straight coupler, the reducing coupler, the second straight coupler, and the 90 degree elbow and a set of instructions.

The present invention holds significant improvements and serves as a drain pipe system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, drain pipe system, constructed and operative according to the teachings of the present invention.

FIG. 1 shows a side view illustrating a drain assembly of the drain pipe system according to an embodiment of the present invention.

FIG. 2 is a perspective view illustrating the drain assembly according to an embodiment of the present invention of FIG. 1.

FIG. 3 is another perspective view illustrating the drain assembly according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a pipe connection means and more particularly to a drain pipe system as used to improve the ease of connection and disconnection between pipes for use with rvs.

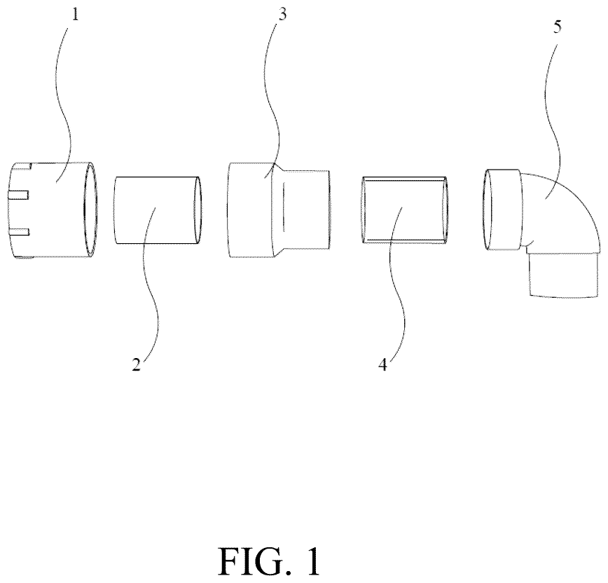

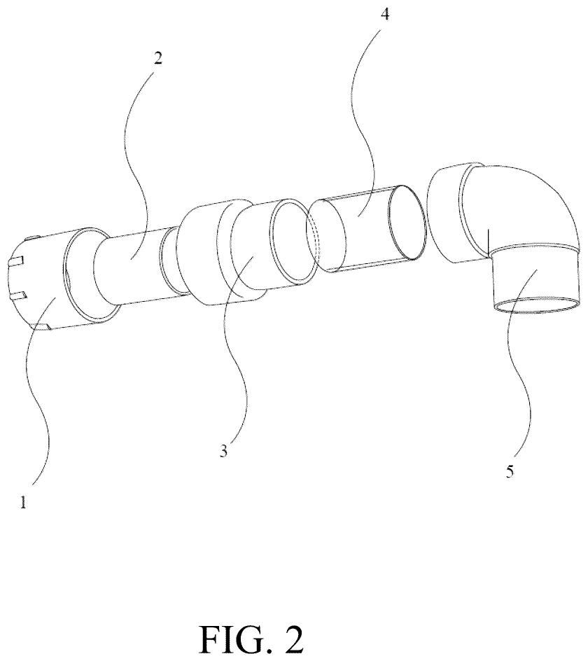

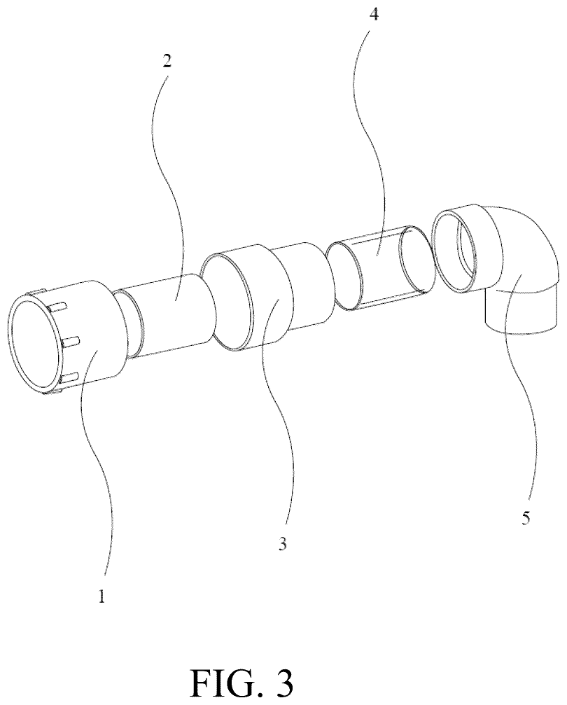

Referring to the drawings by numerals of reference there is shown in FIGS. 1-3, a drain pipe system comprising: a drain pipe assembly including a connector bushing 1, a first straight coupler 2, a reducing coupler 3, a second straight coupler 4, and a 90 degree elbow 5; wherein the connector bushing 1, the first straight coupler 2, the reducing coupler 3, the second straight coupler 4, and the 90 degree elbow 5 are coupled in respective series (for an in-use condition) as the drain pipe assembly configured for connection between a recreational vehicle and a wastewater collection system.

The connector bushing 1 comprises pvc; the first straight coupler 2 comprises pvc; the reducing coupler 3 comprises pvc; the second straight coupler 4 comprises pvc; and the 90 degree elbow 5 comprises pvc. As such the drain pipe assembly entirely comprises pvc in preferred embodiments.

The drain pipe assembly of the drain pipe system does not comprise threads, as shown. The drain pipe assembly can be friction fit assembled (and disassembled). The drain pipe assembly can alternately be adhesively assembled if desired. Those with ordinary skill in the art will now appreciate that upon reading this specification and by their understanding the art of adhesion as described herein, methods and means of coupling will be understood by those knowledgeable in such art as to materials suitable for use and suitable equivalents may be used.

The connector bushing 1 of the drain pipe system comprises a through hole. The connector bushing 1 comprises a plurality of lugs, as shown. The drain pipe assembly of the drain pipe system comprises a ninety degree orientation when assembled, as indicated, however it may comprise a non-ninety degree orientation when assembled if it is appropriate for the application and contours desired.

Relationally speaking, the connector bushing 1 is located on a proximal end and the 90 degree elbow 5 is located on a distal end; the connector bushing 1 on the proximal end, adjacent to the first straight coupler 2, adjacent to the reducing coupler 3, adjacent to the second straight coupler 4, and adjacent to the 90 degree elbow 5, coupled in respective series when assembled. The above-mentioned components couple to each other in male/female relationships.

For the drain pipe assembly of the drain pipe system Polyvinyl Chloride (PVC) is the preferred material used since it is a high-strength thermoplastic material and is chemically resistant to the sewage matter that it transports. Upon reading this specification, it should be appreciated that, under appropriate circumstances, considering such issues as user preferences, design preference, structural requirements, marketing preferences, cost, available materials, technological advances, etc., other material arrangements such as, for example, other plastics, and non-plastics, composites, etc., may be sufficient.

A kit for the drain pipe system may comprise the following parts at least one of the following: the connector bushing 1, the first straight coupler 2, the reducing coupler 3, the second straight coupler 4, and the 90 degree elbow 5 and a set of instructions. The kit has instructions such that functional relationships are detailed in relation to the structure of the invention (such that the invention can be used, maintained, or the like in a preferred manner). The drain pipe system may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, adhesives and non-adhesives, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A drain pipe system comprising:
a drain pipe assembly including
a connector bushing;
a first straight coupler;
a reducing coupler;
a second straight coupler; and
a 90 degree elbow; and
wherein said connector bushing, said first straight coupler, said reducing coupler, said second straight coupler, and said 90 degree elbow are coupled in respective series as said drain pipe assembly configured for connection between a recreational vehicle and a wastewater collection system.

2. The drain pipe system of claim 1 wherein said connector bushing comprises pvc.

3. The drain pipe system of claim 1 wherein said first straight coupler comprises pvc.

4. The drain pipe system of claim 1 wherein said reducing coupler comprises pvc.

5. The drain pipe system of claim 1 wherein said second straight coupler comprises pvc.

6. The drain pipe system of claim 1 wherein said 90 degree elbow comprises pvc.

7. The drain pipe system of claim 1 wherein said drain pipe assembly comprises pvc.

8. The drain pipe system of claim 7 wherein said drain pipe assembly does not comprise threads.

9. The drain pipe system of claim 8 wherein said drain pipe assembly can be friction fit assembled.

10. The drain pipe system of claim 8 wherein said drain pipe assembly can be adhesively assembled.

11. The drain pipe system of claim 9 wherein said connector bushing comprises a through hole.

12. The drain pipe system of claim 1 wherein said connector bushing comprises a plurality of lugs.

13. The drain pipe system of claim 12 wherein said drain pipe assembly comprises a ninety degree orientation when assembled.

14. The drain pipe system of claim 12 wherein said drain pipe assembly comprises a non-ninety degree orientation when assembled.

15. The drain pipe system of claim 1 wherein said connector bushing is located on a proximal end.

16. The drain pipe system of claim 15 wherein said 90 degree elbow is located on a distal end, said connector bushing on said proximal end, adjacent to said first straight coupler, adjacent to said reducing coupler, adjacent to said second straight coupler, and adjacent to said 90 degree elbow, coupled in respective series when assembled.

17. A drain pipe system comprising:
a drain pipe assembly including
a connector bushing;
a first straight coupler;
a reducing coupler;
a second straight coupler; and
a 90 degree elbow; and
wherein said connector bushing, said first straight coupler, said reducing coupler, said second straight coupler, and said 90 degree elbow are coupled in respective series as said drain pipe assembly configured for connection between a recreational vehicle and a wastewater collection system;
wherein said connector bushing, said first straight coupler, said reducing coupler, said second straight coupler, said 90 degree elbow, each comprises pvc, said said drain pipe assembly comprises said pvc;
wherein said drain pipe assembly does not comprise threads;
wherein said drain pipe assembly can be friction fit and alternately adhesively assembled;
wherein said connector bushing comprises a through hole and a plurality of lugs;
wherein said connector bushing is located on a proximal end; and
wherein said 90 degree elbow is located on a distal end, said connector bushing on said proximal end, adjacent to said first straight coupler, adjacent to said reducing coupler, adjacent to said second straight coupler, and adjacent to said 90 degree elbow, coupled in respective series when assembled.

18. The drain pipe system of claim 17 further comprising a kit including: said connector bushing, said first straight coupler, said reducing coupler, said second straight coupler, and said 90 degree elbow and a set of instructions.
